(19) United States
(12) Patent Application Publication
(10) Pub. No.: US 2007/0285228 A1
(43) Pub. Date: Dec. 13, 2007

(54) RETROFIT SENSORS WITH WIRELESS COMMUNICATION CAPABILITIES

(76) Inventor: Frederick O. Fortson, Whitmore Lake, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/761,053

(22) Filed: Jun. 11, 2007

Related U.S. Application Data
(60) Provisional application No. 60/812,932, filed on Jun. 9, 2006.

(51) Int. Cl. G08B 1/08; G08B 21/00

(52) U.S. Cl. 340/539.22; 340/679; 340/539.26

(57) ABSTRACT

A self-enclosed sensing unit may be coupled to an existing mechanism to determine functional characteristics, faults, and other conditions. The unit may contain a wireless communications capability enabling sensed information to be communicated to a remote location for analysis, storage, readout or other purposes, including the control of other devices. The sensed information may be transmitted wirelessly to a receiver interfaced to a vehicle network or other subsystem, thereby facilitating easy integration, including the integration of sensors that move during operation. The unit may be attached in different ways, including magnetism or by way of a threaded interconnect. For example, a bolt-on embodiment may be applied to oil, lubricant or pneumatic ports on vehicles without any mechanical alteration.

### REFERENCE TO RELATED APPLICATION

This application claims priority from U.S. Provisional Patent Application Ser. No. 60/812,932, filed Jun. 9, 2006, the entire content of which is incorporated herein by reference.

### FIELD OF THE INVENTION

This invention relates generally to operating condition sensors and, in particular, to wireless sensors that may be retrofitted to vehicles and other machinery to transmit operating conditions to a remote readout or analysis system.

### BACKGROUND OF THE INVENTION

It is often desirable, if not necessary, to provide vehicles, machines and other apparatus with sensors to determine vibration, temperature and other parameters. While it may be easy to factory install such sensors in hardwired configurations, it can be much more difficult to retrofit sensors onto existing mechanisms, due to the lack of mounting strategies and/or electrical/mechanical infrastructure “hooks.” Thus, the need remains for sensors which may be added to existing machines, vehicles, and the like, without requiring extensive structural or electrical modifications.

### SUMMARY OF THE INVENTION

This invention improves upon existing operational sensors by providing a self-enclosed sensing unit that may be coupled to an existing mechanism to determine functional characteristics, faults, and other conditions. In preferred embodiments the unit contains a wireless communications capability enabling sensed information to be communicated to a remote location for analysis, storage, readout or other purposes, including the control of other devices.

The sensed information may be transmitted wirelessly to a receiver interfaced to a vehicle network or other subsystem, thereby facilitating easy integration, including the integration of sensors that move during operation. The unit may be attached in different ways, including magnetism or by way of a threaded interconnect. For example, a bolt-on embodiment may be applied to oil, lubricant or pneumatic ports on vehicles without any mechanical alteration.

### BRIEF DESCRIPTION OF THE DRAWINGS

FIG. 1 shows a wireless sensor coupled to a rotating shaft in a vehicle to diagnose engine fault; and

FIG. 2 shows a wireless fluid “cleanliness” sensor based upon a battery-powered light-emitting diode and photocell.

### DETAILED DESCRIPTION OF THE INVENTION

This invention improves upon existing operational sensors by providing a self-enclosed sensing unit that may be coupled to an existing mechanism to determine functional characteristics, faults, and other conditions. In the preferred embodiments the unit contains a wireless communications capability enabling sensed information to be communicated to a remote location for analysis, storage, readout or other purposes, including the control of other devices. For example, the sensed information may be transmitted wirelessly to a receiver interfaced to a vehicle network or other subsystem, thereby facilitating easy integration, including the integration of sensors that move during operation.

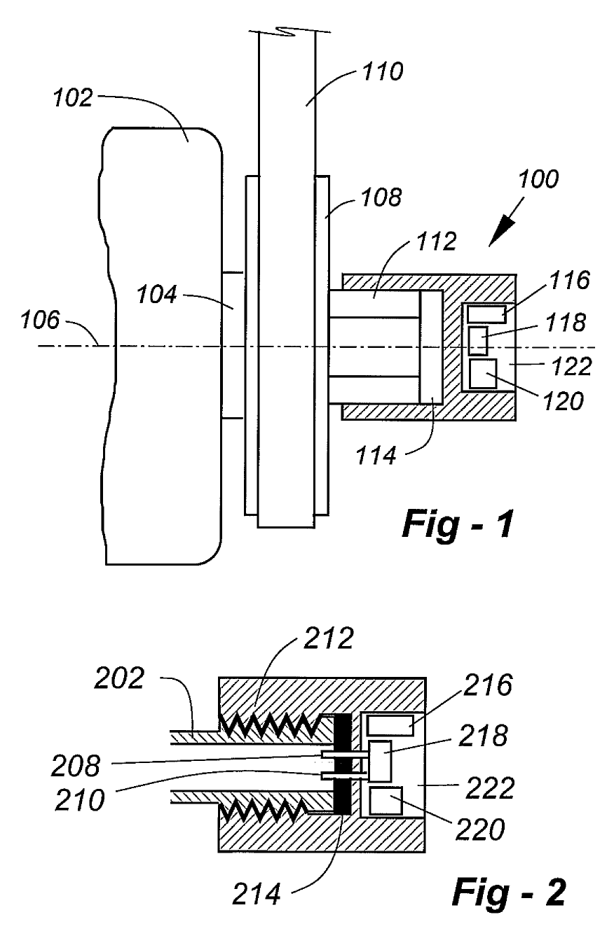

The unit may be attached in different ways, including magnetism or by way of a threaded interconnect. For example, a bolt-on embodiment may be applied to oil, lubricant or pneumatic ports on vehicles without any mechanical alteration. FIG. 1 shows a sensor unit 100 coupled to a shaft 104. In this case the shaft 104 is a crank shaft rotatable about axis 106. The crank shaft 104 is coupled to a pulley 108 turning a belt 110. The sensor unit 100 may be coupled to the shaft by way of a bolt 112 and/or strong permanent magnet 114.

Disposed inside the sensor body is a speed-sensing device 116, battery 118 and RF transmitter 120. The devices are encapsulated using an overmold 122 resulting in an implementation that is rugged, wireless, self-charging and adaptable to different components. Though not shown, a coil and moving core may be used to generate electricity and change battery 118 to extend operating life.

Different types of characteristics may be sensed, including temperature, pressure, cleanliness/turbidity, color, viscosity, or any other quality so long as a sensor is available for such purpose. FIG. 2, for example, shows a fluid “cleanliness” sensor 212 using a light-emitting diode 208 and opposing photocell 210 powered by battery 218. Low-power processing electronics 216 connected to these components generate a burst of light on a periodic basis, with the reception at the detector being monitored and used to estimate the level of particulates or foreign matter in a fluid such as engine or transmission fluid. The body 212 of the sensor in this case is preferably threaded, enabling the unit to be bolted onto existing fluid intake or drain ports. A seal is indicated at 214, with overmolding again being used at 222. Since this embodiment is stationary, a hardwired connection may be used as opposed to wireless transmitter 220.

I claim:

1. A retrofit sensor, comprising:
a body including a battery and a sensor operated by the battery;
a mechanism enabling the body to be attached to an existing piece of machinery to determine operational data using the sensor; and
an interface for communicating the operational data to a separate unit for display, analysis, or control.

2. The retrofit sensor of claim 1, wherein the mechanism is a threaded connector enabling the body to be bolted onto an existing piece of machinery.

3. The retrofit sensor of claim 1, wherein the interface includes a wireless transmitter operative to transmit the operational data to the separate unit.

4. The retrofit sensor of claim 1, wherein:
the mechanism is a threaded connector enabling the body to be bolted onto an existing fluid port; and
the operational data includes one or more characteristics of the fluid.

5. The retrofit sensor of claim 1, wherein:
the mechanism is a threaded connector enabling the body to be bolted onto an existing fluid port;
the body includes a passage for receiving a fluid to be tested; and
the sensor includes:
a source of light directed on the fluid;
a light detector to receive light from the source after passing through the fluid; and
a processor in communication with the detector for determining a level of particulates in the fluid.

6. The retrofit sensor of claim 1, wherein:
the mechanism is a threaded connector enabling the body to be bolted onto an existing fluid port;
the body includes a passage for receiving a fluid to be tested; and
the sensor includes:
a source of light directed on the fluid;
a light detector to receive light from the source after passing through the fluid;
a processor in communication with the detector for determining a level of particulates in the fluid; and
a wireless transmitter operative to transmit sensed data to a receiver.
